(19) United States
(12) Patent Application Publication
(10) Pub. No.: US 2026/0120076 A1
(43) Pub. Date: Apr. 30, 2026

(54) CLIENT-SIDE REQUESTS FOR NEW VIRTUAL IDENTIFIERS

(71) Applicant: Capital One Services, LLC, McLean, VA (US)

(72) Inventors: Jackson MACOMBER, Henrico, VA (US); Jeffrey Carlyle WIEKER, Falls Church, VA (US); Jeffrey RULE, Chevy Chase, MD (US)

(21) Appl. No.: 18/933,098

(22) Filed: Oct. 31, 2024

(51) Int. Cl. G06Q 20/34; G06Q 20/40

(52) U.S. Cl. CPC G06Q 20/351; G06Q 20/40; G06Q 2220/10

(57) ABSTRACT

In some implementations, a processing device may receive an indication of a triggering event associated with a virtual identifier. The processing device may determine to request the new virtual identifier based on the triggering event. The processing device may transmit, to an identifier manager associated with the virtual identifier, a request for the new virtual identifier. The processing device may receive, from the identifier manager, an indication of the new virtual identifier in response to the request. The processing device may store the indication of the new virtual identifier, in replacement of an indication of the virtual identifier, for processing future events.

### BACKGROUND

To improve security in a computerized system, virtual identifiers may be used in place of permanent identifiers. For example, a virtual card number (VCN) may be used in place of a payment account number (PAN). Tokenizing the PAN into the VCN improves security because the VCN may be replaced, if compromised, more easily than the PAN.

### SUMMARY

Some implementations described herein relate to a system for requesting a new virtual identifier. The system may include one or more memories and one or more processors communicatively coupled to the one or more memories. The one or more processors may be configured to receive an indication of a triggering event associated with a virtual identifier. The one or more processors may be configured to provide a data structure representing a set of events, associated with the virtual identifier, to a machine learning model in order to receive a score associated with the virtual identifier. The one or more processors may be configured to determine to request the new virtual identifier based on the triggering event and the score. The one or more processors may be configured to transmit, to an identifier manager associated with the virtual identifier, a request for the new virtual identifier. The one or more processors may be configured to receive, from the identifier manager and in response to the request, an indication of the new virtual identifier. The one or more processors may be configured to store the indication of the new virtual identifier, in replacement of an indication of the virtual identifier, for processing future events.

Some implementations described herein relate to a method of requesting a new virtual identifier. The method may include receiving, at a processing device, an indication of a triggering event associated with a virtual identifier. The method may include determining, by the processing device, to request the new virtual identifier based on the triggering event. The method may include transmitting, from the processing device and to an identifier manager associated with the virtual identifier, a request for the new virtual identifier. The method may include receiving, from the identifier manager and at the processing device, an indication of the new virtual identifier in response to the request. The method may include storing, at the processing device, the indication of the new virtual identifier, in replacement of an indication of the virtual identifier, for processing future events.

Some implementations described herein relate to a non-transitory computer-readable medium that stores a set of instructions for processing a request for a new virtual identifier. The set of instructions, when executed by one or more processors of a device, may cause the device to receive, from a processing device associated with the virtual identifier, the request for the new virtual identifier, wherein the request includes a reason code associated with a triggering event. The set of instructions, when executed by one or more processors of the device, may cause the device to determine a response to the request. The set of instructions, when executed by one or more processors of the device, may cause the device to transmit, to the processing device, the response.

### BRIEF DESCRIPTION OF THE DRAWINGS

FIGS. 1A-1E are diagrams of an example implementation relating to client-side requests for new virtual identifiers, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIG. 4 is a flowchart of an example process relating to transmitting a client-side request for a new virtual identifier, in accordance with some embodiments of the present disclosure.

FIG. 5 is a flowchart of an example process relating to receiving a client-side request for a new virtual identifier, in accordance with some embodiments of the present disclosure.

### DETAILED DESCRIPTION

The following detailed description of example implementations refers to the accompanying drawings. The same reference numbers in different drawings may identify the same or similar elements.

To improve security in a computerized system, virtual identifiers may be used in place of permanent identifiers. For example, a VCN may be used in place of a PAN. Tokenizing the PAN into the VCN improves security because the VCN may be replaced, if compromised, more easily than the PAN. As a result, computer resources are conserved.

Risk of compromise may increase the longer and/or more often that the VCN is used. Therefore, the VCN may be periodically rotated. However, an authorized party (e.g., a merchant) that stores the VCN may suffer a breach or otherwise detect an increase in risk to the VCN before a system that issued the VCN is aware of the increased risk. Therefore, because the VCN is rotated periodically by the system that issued the VCN, security is reduced. In particular, the VCN is more likely to be stolen or otherwise compromised before replacement, which may not occur for days or even weeks. Additionally, computer resources are wasted undoing any fraudulent events (e.g., transactions) performed using the VCN.

Some implementations described herein enable a processing device (e.g., a merchant device) to request a new virtual identifier (e.g., a new VCN) in response to a triggering event. As a result, security is improved because a virtual identifier may be replaced when the processing device detects an increased risk, rather than the processing device waiting for an identifier manager (e.g., associated with an institution that issued the virtual identifier) to replace the virtual identifier. Additionally, computer resources are conserved that otherwise would have been spent in undoing any fraudulent events (e.g., transactions) performed using the virtual identifier.

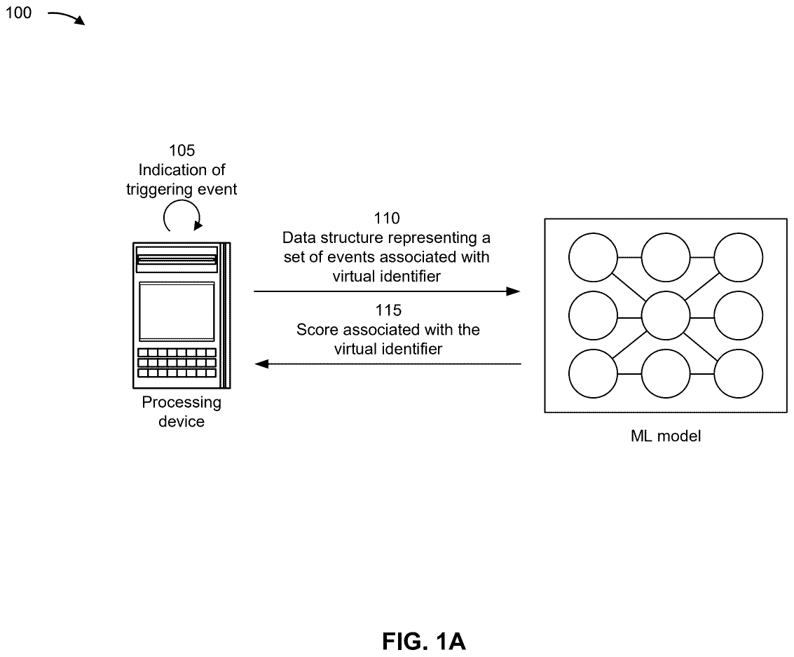

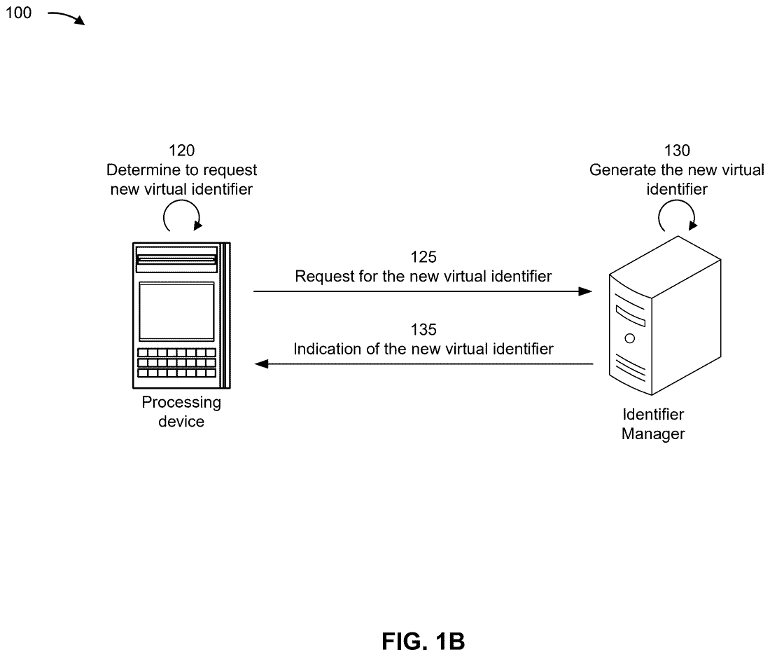

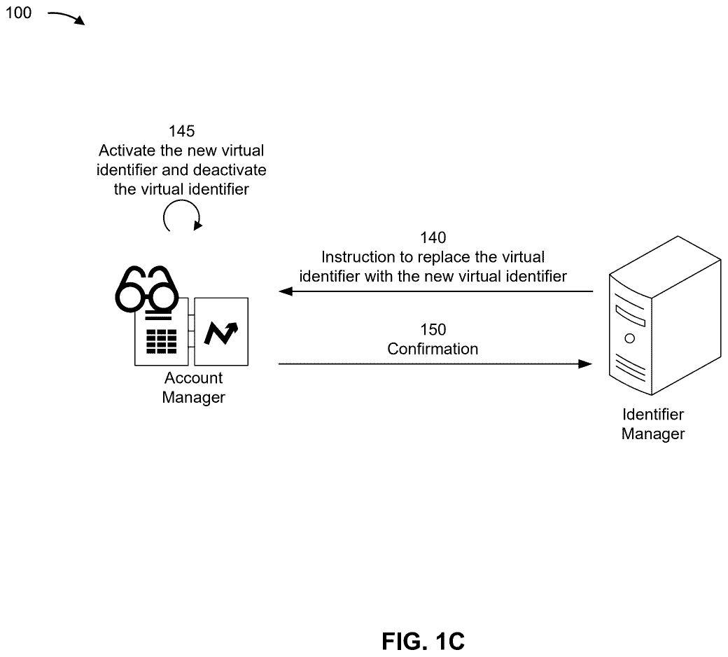

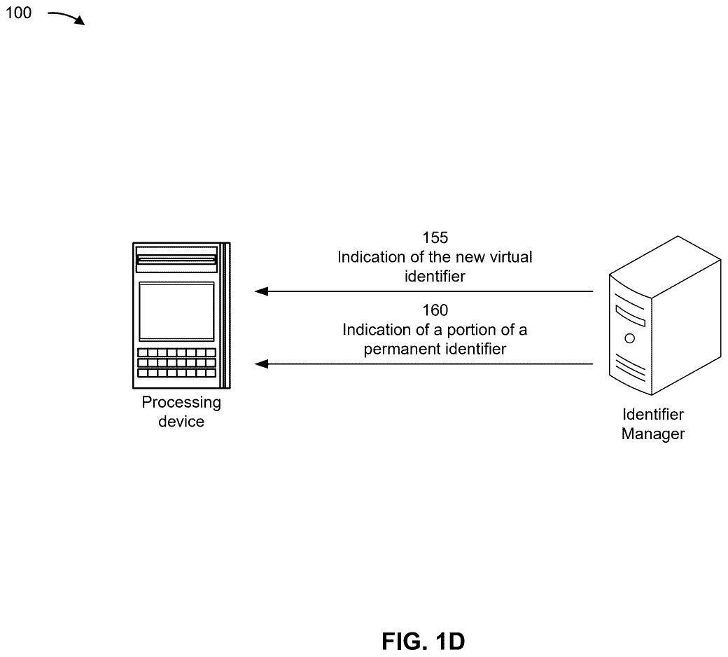

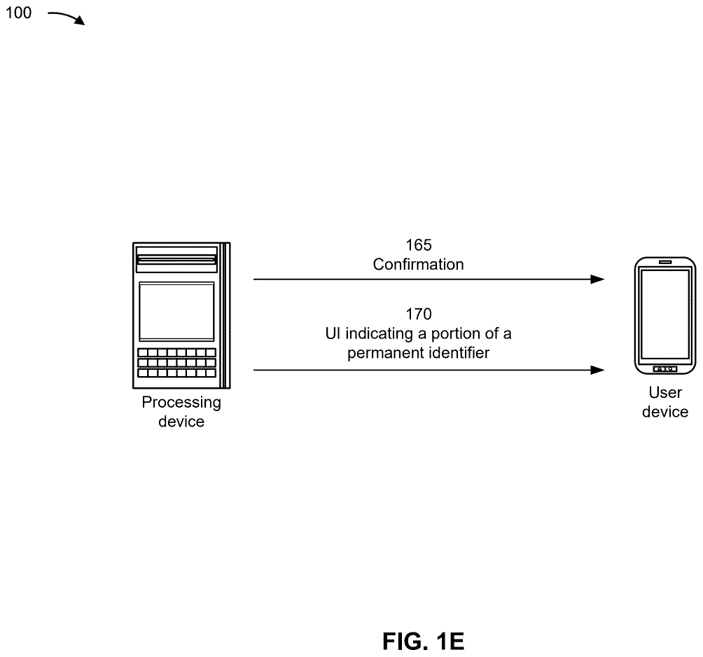

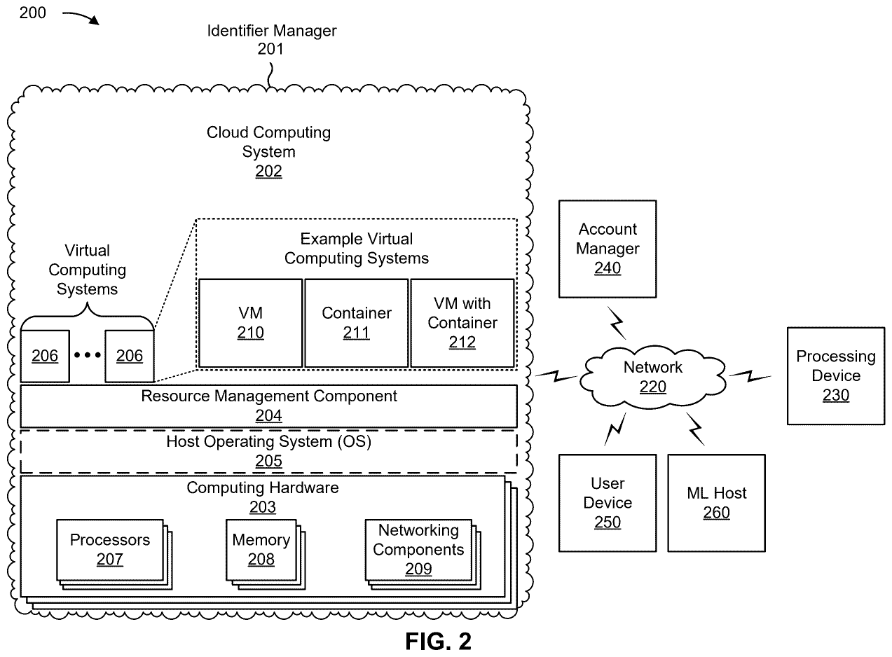

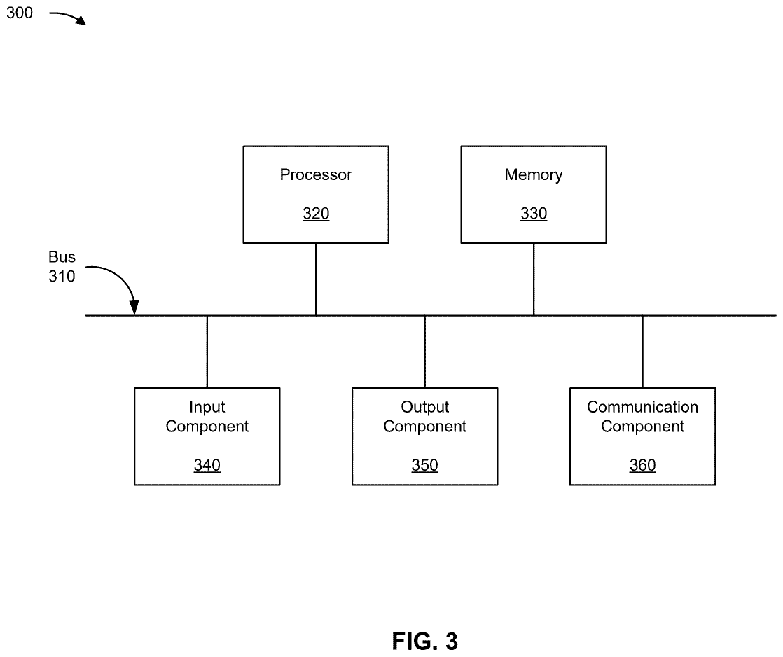

FIGS. 1A-1E are diagrams of an example 100 associated with client-side requests for new virtual identifiers. As shown in FIGS. 1A-1E, example 100 includes a processing device, a machine learning (ML) model (e.g., provided by an ML host), an identifier manager, an account manager, and a user device. In the example 100, the client-side may refer to the processing device (rather than the identifier manager and the account manager). These devices are described in more detail in connection with FIGS. 2 and 3.

As shown in FIG. 1A and by reference number 105, the processing device may receive an indication of a triggering event associated with a virtual identifier. For example, the processing device may receive the indication from monitoring software executed by the processing device. Accordingly, the indication may be a flag, a bit, or another type of data structure generated by the monitoring software and representing the triggering event. Alternatively, the processing device may receive the indication from an external system. For example, the external system may indicate a data breach, a browsing event, or another type of triggering event that occurred separately from the processing device. The virtual identifier may include a VCN or another type of identifier that is linked to, but different than, a permanent identifier (e.g., a PAN, among other examples).

In some implementations, the triggering event may include an expiration associated with the virtual identifier and/or a decline event associated with the virtual identifier. For example, the processing device may detect expiration of the virtual identifier using a current date (or datetime), where an indication of the expiration functions as an indication of the triggering event. In another example, the processing device may receive (e.g., from a payment processing device and/or the account manager, among other examples) a rejection of an event (e.g., a transaction) using the virtual identifier, where the rejection functions as an indication of the triggering event. Additionally, or alternatively, the triggering event may include a security breach associated with the processing device and/or a login event associated with the processing device. For example, the processing device may receive (e.g., from a data security system, among other examples) an indication of a data breach, where the indication of the data breach functions as an indication of the triggering event. In another example, the processing device may receive (e.g., from a web host and/or the user device, among other examples) an indication that a user has attempted (and failed) to login (either once or multiple times), where the indication that the user has attempted to login functions as an indication of the triggering event. Additionally, or alternatively, the triggering event may include a password event associated with the processing device and/or a browsing event associated with the processing device. For example, the processing device may receive (e.g., from a web host and/or the user device, among other examples) an indication that a user has reset a password associated with an account of the user, where the indication that the user has reset the password functions as an indication of the triggering event. In another example, the processing device may receive (e.g., from a web host and/or the user device, among other examples) an indication that one or more browsing actions of a user are similar to a profile associated with bots, where the indication that the browsing action(s) are similar to the profile functions as an indication of the triggering event.

In some implementations, the processing device may update a score, associated with the virtual identifier, in response to the triggering event. For example, the processing device may receive an indication of a set of events, associated with the virtual identifier, to use for updating the score. The processing device may receive the indication from a local storage (e.g., a cache and/or another type of memory controlled by the processing device) and/or from a remote storage (e.g., a device at least partially separate from the processing device). The indication of the set of events may be received using a push (e.g., transmitted by the remote storage in response to generation of at least one new event). Alternatively, the indication of the set of events may be received using a pull (e.g., received in response to a request, transmitted by the processing device, for the set of events).

As shown by reference number 110, the processing device may provide, to the ML model, a data structure representing the set of events associated with the virtual identifier. For example, the processing device may provide a data structure representing a set of transactions, using the virtual identifier, to the ML model. In some implementations, the processing device may transmit, and the ML host associated with the ML model may receive, a request including the data structure. The ML model may be trained (e.g., by the ML host and/or a device at least partially separate from the ML host) to score virtual identifiers. The ML model may be trained using events, associated with virtual identifiers, that are labeled by administrators or other types of users (e.g., for supervised learning). Additionally, or alternatively, the ML model may be trained using events that are unlabeled (e.g., for deep learning).

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., events associated with virtual identifiers). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the ML host, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 115, the ML model may output the score associated with the virtual identifier. For example, the processing device may receive the score from the ML model (e.g., from the ML host). The score may be an integer or a decimal value representing risk associated with the virtual identifier. For example, the score may be a score out of 10 or out of 100, among other examples. Additionally, or alternatively, the score may be qualitative, such as a letter grade or a risk category (e.g., “high” risk or “low” risk, among other examples).

As shown in FIG. 1B and by reference number 120, the processing device may determine to request a new virtual identifier. For example, the processing device may determine to request a new virtual identifier based on (e.g., in response to) the triggering event. In some implementations, the processing device may determine to request a new virtual identifier in response to a plurality of triggering events (within a time window), where a quantity of the triggering events satisfies an event threshold. Additionally, or alternatively, the processing device may determine to request a new virtual identifier based on the score. In some implementations, the processing device may determine to request a new virtual identifier in response to the score satisfying a replacement threshold.

Although the example 100 is shown with the ML model and the score, other examples may omit the ML model (and/or the score). For example, the processing device may determine to request a new virtual identifier in response to the triggering event (or a plurality of triggering events) without requesting the ML model to calculate the score.

As shown by reference number 125, the processing device may transmit, and the identifier manager may receive, a request for the new virtual identifier. The request may include a hypertext transfer protocol (HTTP) request, a file transfer protocol (FTP) request, and/or an application programming interface (API) call. Therefore, the processing device may transmit the request by performing an API call to an API function associated with virtual identifier replacement. In some implementations, the request may include an indication of the virtual identifier. For example, the request may include a token with an encrypted version of the virtual identifier.

The identifier manager may be associated with the virtual identifier. For example, a portion of the virtual identifier (e.g., an initial digit, a terminating digit, or another portion of the virtual identifier) may be associated with the identifier manager. The processing device may use a data structure (e.g., stored locally at the processing device or remotely accessed by the processing device) to map the portion of the virtual identifier to an indication of the identifier manager (e.g., a name of the identifier manager, an Internet protocol (IP) address of the identifier manager, and/or a medium access control (MAC) address of the identifier manager, among other examples).

The identifier manager may validate the indication of the virtual identifier included in the request. Additionally, or alternatively, the request may include a set of credentials associated with the processing device, and the identifier manager may validate the set of credentials (e.g., before processing the request). The set of credentials may include a username and password, a passkey, a certificate, a signature, a private key, and/or biometric information, among other examples. In some implementations, the processing device may transmit the set of credentials separately from the request. For example, the processing device may transmit the set of credentials initially, and the identifier manager may accept the request from the processing device in response to validating the set of credentials. In another example, the identifier manager may prompt the processing device in response to the request, and the processing device may transmit the set of credentials in response to the prompt. Accordingly, the identifier manager may validate the set of credentials and may process the request in response to validating the set of credentials.

In some implementations, the request may include a reason code associated with the triggering event. For example, the reason code may be included in a field (e.g., for an integer or another type of data element), and a codepoint of the field may map to a reason from a plurality of possible reasons (e.g., using a table or another type of data structure that stores the plurality of possible reasons in association with a plurality of codepoints). In one example, the reason code may indicate the type of triggering event. Accordingly, the processing device may set the reason code based on a type (or a category) of the triggering event.

Additionally, or alternatively, the request may include an indication that a score, associated with the virtual identifier, satisfies a replacement threshold (e.g., as described above). For example, the processing device may use a Boolean (or another type of bit) to indicate whether the score satisfies the replacement threshold. In some implementations, the request may further include the score. For example, the processing device may encode the score into a field of the request.

The identifier manager may determine a response to the request from the processing device. The identifier manager may transmit, and the processing device may receive, the response. For example, the response may be a rejection of the request. Accordingly, the response may include a reason code associated with the rejection. The reason code may be included in a field (e.g., for an integer or another type of data element), and a codepoint of the field may map to a reason from a plurality of possible reasons (e.g., using a table or another type of data structure that stores the plurality of possible reasons in association with a plurality of codepoints). For example, the reason code may indicate that the virtual identifier is too new to be replaced or that the processing device is not authorized to request a new virtual identifier, among other examples.

Alternatively, the response may be an acceptance of the request. Accordingly, as shown by reference number 130, the identifier manager may generate the new virtual identifier. For example, the identifier manager may generate the new virtual identifier using pseudo-random number generation and/or algorithmic modification of the permanent identifier associated with the virtual identifier (and to be associated with the new virtual identifier), among other examples. The identifier manager may transmit, and the processing device may receive, the response. For example, as shown by reference number 135, the response may include an indication of the new virtual identifier. The identifier manager may transmit, and the processing device may receive, the indication of the new virtual identifier in response to the request from the processing device.

As shown in FIG. 1C and by reference number 140, the identifier manager may transmit, and the account manager may receive, an instruction to replace the virtual identifier with the new virtual identifier. As shown by reference number 145, the account manager may deactivate the virtual identifier and activate the new virtual identifier. Therefore, the account manager may authorize future requests associated with the new virtual identifier (e.g., by approving transactions or other events that use the new virtual identifier). Additionally, the account manager may disable the virtual identifier such that future requests associated with the virtual identifier are rejected (e.g., transactions or other events that use the virtual identifier are denied).

In some implementations, the account manager may discard the virtual identifier in response to the instruction. Alternatively, the account manager may retain the virtual identifier (in association with the permanent identifier) while refraining from authorizing any future requests associated with the virtual identifier. As shown by reference number 150, the account manager may transmit, and the identifier manager may receive, a confirmation that the new virtual identifier is active.

Although the example 100 depicts the identifier manager as separate from the account manager, other examples may include the account manager as at least partially integrated (e.g., virtually, logically, and/or physically) with the identifier manager. Therefore, operations described herein as performed by the account manager may be performed by the identifier manager. For example, the identifier manager may disable the virtual identifier (e.g., such that future requests associated with the virtual identifier are rejected) and may activate the new virtual identifier (e.g., such that future requests associated with the new virtual identifier are approved).

As shown in FIG. 1D and by reference number 155, the identifier manager may transmit, and the processing device may receive, the indication of the new virtual identifier. For example, the identifier manager may transmit, and the processing device may receive, the indication of the new virtual identifier in response to the request from the processing device (e.g., as described in connection with FIG. 1A) and/or the confirmation from the account manager.

Alternatively, the account manager may transmit, and the processing device may receive, the indication of the new virtual identifier. For example, the account manager may transmit the indication of the new virtual identifier to devices (e.g., one or more devices) using the virtual identifier, which includes the processing device. Therefore, any devices using the virtual identifier are informed that the virtual identifier is being replaced with the new virtual identifier. In some implementations, the identifier manager (rather than the account manager) may transmit the indication of the new virtual identifier to the devices using the virtual identifier. Accordingly, the identifier manager may identify the devices using the virtual identifier from a list of devices associated with the permanent identifier. Additionally, or alternatively, the account manager may transmit, and the identifier manager may receive, an indication of the devices using the virtual identifier.

In response to receiving the indication of the new virtual identifier, the processing device may store the indication of the new virtual identifier, in replacement of an indication of the virtual identifier, for processing future events. For example, the processing device may store a token that includes an encrypted version of the new virtual identifier. Therefore, the processing device may use the new virtual identifier for future requests (e.g., associated with future transactions or other events). Additionally, in some implementations, the processing device may discard the virtual identifier. For example, the processing device may discard a token that includes an encrypted version of the virtual identifier. Therefore, the event device may refrain from using the virtual identifier for future requests (e.g., associated with future transactions or other events) because the account manager (and/or the identifier manager) will reject future requests associated with the virtual identifier.

In addition to the indication of the new virtual identifier, the identifier manager may transmit, and the processing device may receive, an indication of a portion of the permanent identifier, as shown by reference number 160. Accordingly, even though the processing device was using the virtual identifier (and subsequently uses the new virtual identifier), the processing device may output the portion of the permanent identifier in order to improve a user's experience.

As shown in FIG. 1E, in one example, the processing device may transmit, and the user device may receive, a confirmation that the virtual identifier has been replaced with the new virtual identifier, as shown by reference number 165. Additionally, or alternatively, the processing device may output the confirmation directly to a user (e.g., using an output component of the processing device). In some implementations, the processing device may further transmit, and the user device may further receive, instructions for a user interface (UI) indicating the portion of the permanent identifier (associated with the virtual identifier and the new virtual identifier), as shown by reference number 170. The portion of the permanent identifier may include, among other examples, a final four digits of the permanent identifier. Additionally, or alternatively, the processing device may output the portion of the permanent identifier directly to a user (e.g., using an output component of the processing device).

By using techniques as described in connection with FIGS. 1A-1E, the processing device requests the new virtual identifier in response to the triggering event. As a result, security is improved because the virtual identifier may be replaced when the processing device detects an increased risk, rather than the processing device waiting for the identifier manager to replace the virtual identifier. Additionally, computer resources are conserved that otherwise would have been spent undoing any fraudulent events (e.g., transactions) performed using the virtual identifier.

As indicated above, FIGS. 1A-1E are provided as an example. Other examples may differ from what is described with regard to FIGS. 1A-1E.

FIG. 2 is a diagram of an example environment 200 in which systems and/or methods described herein may be implemented. As shown in FIG. 2, environment 200 may include a identifier manager 201, which may include one or more elements of and/or may execute within an cloud computing system 202. The cloud computing system 202 may include one or more elements 203-212, as described in more detail below. As further shown in FIG. 2, environment 200 may include a network 220, a processing device 230, an account manager 240, a user device 250, and/or an ML host 260. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the identifier manager 201 may include one or more elements 203-212 of the cloud computing system 202, may execute within the cloud computing system 202, and/or may be hosted within the cloud computing system 202, in some implementations, the identifier manager 201 may not be cloud-based (e.g., may be implemented outside of a cloud computing system) or may be partially cloud-based. For example, the identifier manager 201 may include one or more devices that are not part of the cloud computing system 202, such as device 300 of FIG. 3, which may include a standalone server or another type of computing device. The identifier manager 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The processing device 230 may include one or more devices capable of facilitating an electronic event. For example, the processing device 230 may include a point-of-sale (PoS) terminal, a payment terminal (e.g., a credit card terminal, a contactless payment terminal, a mobile credit card reader, or a chip reader), and/or an automated teller machine (ATM). In some implementations, the processing device 230 may include an access control terminal (e.g., used to control physical access to a secure area), such as an access control panel used to control an access-controlled entry (e.g., a turnstile, a door, a gate, or another physical barrier). The processing device 230 may include one or more input components and/or one or more output components to facilitate interaction with a physical card and/or the user device 250. Example input components of the processing device 230 include a number keypad, a touchscreen, a magnetic stripe reader, a chip reader, and/or a radio frequency (RF) signal reader (e.g., a near field communication (NFC) reader). Example output components of the processing device 230 include a display and/or a speaker. The processing device 230 may communicate with one or more other devices of environment 200, as described elsewhere herein.

The account manager 240 may include one or more devices capable of processing, authorizing, and/or facilitating an event (e.g., a transaction). For example, the account manager 240 may include one or more servers and/or computing hardware (e.g., in a cloud computing environment or separate from a cloud computing environment) configured to receive and/or store information associated with processing an electronic event. The account manager 240 may process an event, such as to approve (e.g., permit, authorize, or the like) or decline (e.g., reject, deny, or the like) the event and/or to complete the event if the event is approved. The account manager 240 may be associated with a financial institution (e.g., a bank, a lender, a credit card company, or a credit union). For example, the account manager 240 may be associated with an issuing bank and/or an acquiring bank (or merchant bank). The account manager 240 may communicate with one or more other devices of environment 200, as described elsewhere herein.

The user device 250 may include one or more devices capable of receiving, generating, storing, processing, and/or providing information associated with virtual identifiers, as described elsewhere herein. The user device 250 may include a communication device and/or a computing device. For example, the user device 250 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 250 may communicate with one or more other devices of environment 200, as described elsewhere herein.

The ML host 260 may include one or more devices capable of receiving, generating, storing, processing, and/or providing information associated with machine learning models, as described elsewhere herein. The ML host 260 may include a communication device and/or a computing device. For example, the ML host 260 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 260 may communicate with one or more other devices of environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with client-side requests for new virtual identifiers. The device 300 may correspond to a processing device 230, an account manager 240, a user device 250, and/or an ML host 260. In some implementations, a processing device 230, an account manager 240, a user device 250, and/or an ML host 260 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

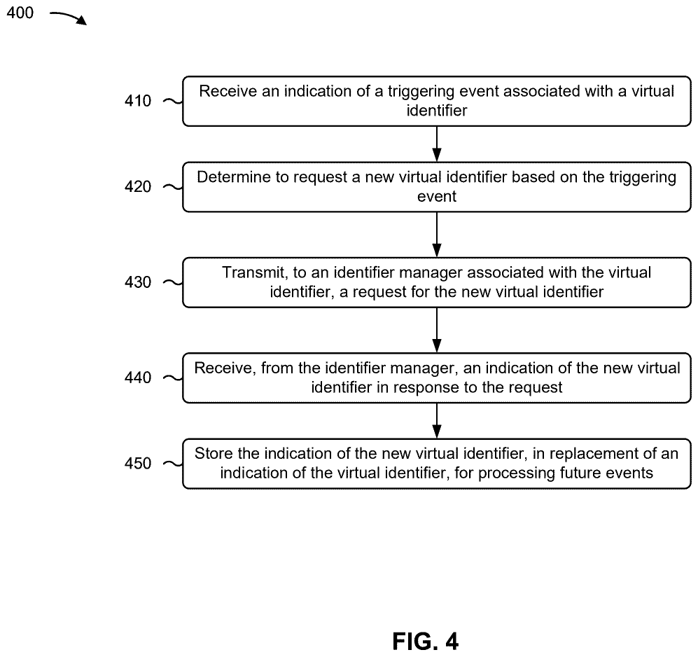

FIG. 4 is a flowchart of an example process 400 associated with transmitting a client-side request for a new virtual identifier. In some implementations, one or more process blocks of FIG. 4 may be performed by a processing device 230. In some implementations, one or more process blocks of FIG. 4 may be performed by another device or a group of devices separate from or including the processing device 230, such as an identifier manager 201, an account manager 240, a user device 250, and/or an ML host 260. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving an indication of a triggering event associated with a virtual identifier (block 410). For example, the processing device 230 (e.g., using processor 320, memory 330, input component 340, and/or communication component 360) may receive an indication of a triggering event associated with a virtual identifier, as described above in connection with reference number 105 of FIG. 1A. As an example, the processing device 230 may receive the indication from monitoring software executed by the processing device 230 and/or may receive the indication from an external system. In some implementations, the triggering event may include an expiration associated with the virtual identifier, a decline event associated with the virtual identifier, a security breach associated with the processing device 230, a login event associated with the processing device 230, a password event associated with the processing device 230, and/or a browsing event associated with the processing device 230.

As further shown in FIG. 4, process 400 may include determining to request a new virtual identifier based on the triggering event (block 420). For example, the processing device 230 (e.g., using processor 320 and/or memory 330) may determine to request a new virtual identifier based on the triggering event, as described above in connection with reference number 120 of FIG. 1B. As an example, the processing device 230 may determine to request a new virtual identifier in response to the triggering event. In some implementations, the processing device 230 may determine to request a new virtual identifier in response to a plurality of triggering events (within a time window), where a quantity of the triggering events satisfies an event threshold. Additionally, the processing device 230 may determine to request a new virtual identifier based on a score associated with the virtual identifier. In some implementations, the processing device 230 may determine to request a new virtual identifier in response to the score satisfying a replacement threshold.

As further shown in FIG. 4, process 400 may include transmitting, to an identifier manager associated with the virtual identifier, a request for the new virtual identifier (block 430). For example, the processing device 230 (e.g., using processor 320, memory 330, and/or communication component 360) may transmit, to an identifier manager associated with the virtual identifier, a request for the new virtual identifier, as described above in connection with reference number 125 of FIG. 1. As an example, the request may include an indication of the virtual identifier (e.g., a token with an encrypted version of the virtual identifier). Additionally, or alternatively, the request may include a set of credentials associated with the processing device 230. Additionally, or alternatively, the request may include a reason code associated with the triggering event. Additionally, or alternatively, the request may include an indication that a score, associated with the virtual identifier, satisfies a replacement threshold (and/or may include the score itself).

As further shown in FIG. 4, process 400 may include receiving, from the identifier manager, an indication of the new virtual identifier in response to the request (block 440). For example, the processing device 230 (e.g., using processor 320, memory 330, and/or communication component 360) may receive, from the identifier manager, an indication of the new virtual identifier in response to the request, as described above in connection with reference number 135 of FIG. 1B. As an example, the processing device 230 may receive the indication of the new virtual identifier in response to the request transmitted to the identifier manager.

As further shown in FIG. 4, process 400 may include storing the indication of the new virtual identifier, in replacement of an indication of the virtual identifier, for processing future events (block 450). For example, the processing device 230 (e.g., using processor 320 and/or memory 330) may store the indication of the new virtual identifier, in replacement of an indication of the virtual identifier, for processing future events, as described above in connection with FIG. 1D. As an example, the processing device 230 may store a token that includes an encrypted version of the new virtual identifier.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1E. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

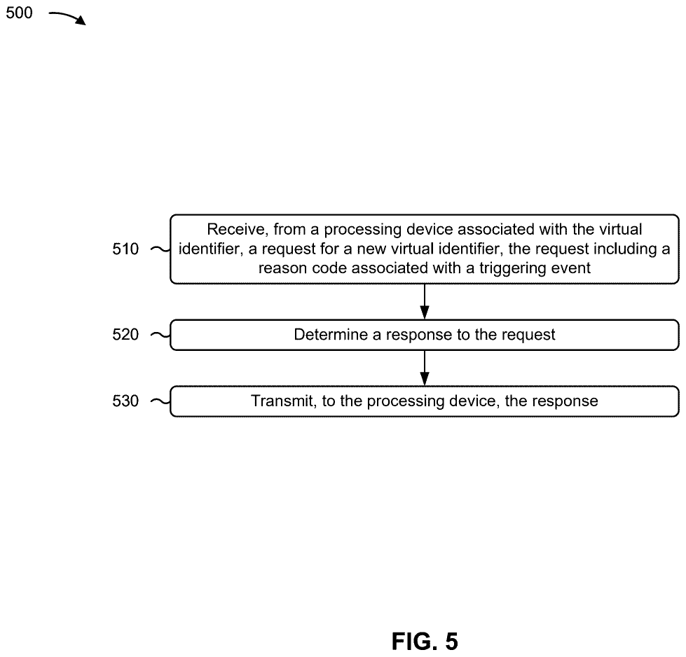

FIG. 5 is a flowchart of an example process 500 associated with receiving a client-side request for a new virtual identifier. In some implementations, one or more process blocks of FIG. 5 may be performed by an identifier manager 201. In some implementations, one or more process blocks of FIG. 5 may be performed by another device or a group of devices separate from or including the identifier manager 201, such as a processing device 230, an account manager 240, a user device 250, and/or an ML host 260. Additionally, or alternatively, one or more process blocks of FIG. 5 may be performed by one or more components of the device 300, such as processor 320, memory 330, input component 340, output component 350, and/or communication component 360.

As shown in FIG. 5, process 500 may include receiving, from a processing device associated with the virtual identifier, the request for the new virtual identifier, the request including a reason code associated with a triggering event (block 510). For example, the identifier manager 201 (e.g., using processor 320, memory 330, and/or communication component 360) may receive, from a processing device associated with the virtual identifier, the request for the new virtual identifier, the request including a reason code associated with a triggering event, as described above in connection with reference number 125 of FIG. 1B. As an example, the request may include an indication of the virtual identifier (e.g., a token with an encrypted version of the virtual identifier). Additionally, or alternatively, the request may include a set of credentials associated with the processing device. Additionally, or alternatively, the request may include a reason code associated with the triggering event. Additionally, or alternatively, the request may include an indication that a score, associated with the virtual identifier, satisfies a replacement threshold (and/or may include the score itself).

As further shown in FIG. 5, process 500 may include determining a response to the request (block 520). For example, the identifier manager 201 (e.g., using processor 320 and/or memory 330) may determine a response to the request, as described above in connection with FIG. 1B. As an example, the response may be a rejection of the request. Accordingly, the response may include a reason code associated with the rejection. Alternatively, the response may be an acceptance of the request. Accordingly, the identifier manager 201 may generate the new virtual identifier (e.g., using pseudo-random number generation and/or algorithmic modification of a permanent identifier associated with the virtual identifier and to be associated with the new virtual identifier, among other examples).

As further shown in FIG. 5, process 500 may include transmitting, to the processing device, the response (block 530). For example, the identifier manager 201 (e.g., using processor 320, memory 330, and/or communication component 360) may transmit, to the processing device, the response, as described above in connection with FIG. 1B. As an example, the response may be a rejection (and may include a reason code associated with the rejection). Alternatively, the response may be an acceptance, and the response may include an indication of the new virtual identifier.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1E. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for requesting a new virtual identifier, the system comprising:
one or more memories; and
one or more processors, communicatively coupled to the one or more memories, configured to:
receive an indication of a triggering event associated with a virtual identifier;
provide a data structure representing a set of events, associated with the virtual identifier, to a machine learning model in order to receive a score associated with the virtual identifier;
determine to request the new virtual identifier based on the triggering event and the score;
transmit, to an identifier manager associated with the virtual identifier, a request for the new virtual identifier;
receive, from the identifier manager and in response to the request, an indication of the new virtual identifier; and
store the indication of the new virtual identifier, in replacement of an indication of the virtual identifier, for processing future events.

2. The system of claim 1, wherein the request includes a reason code associated with the triggering event.

3. The system of claim 1, wherein the one or more processors are configured to:
discard the virtual identifier based on storing the new virtual identifier.

4. The system of claim 1, wherein the indication of the new virtual identifier comprises a token including an encrypted version of the new virtual identifier.

5. The system of claim 1, wherein the one or more processors, to determine to request the new virtual identifier, are configured to:
determine to request the new virtual identifier based on the score satisfying a replacement threshold.

6. The system of claim 1, wherein the one or more processors are configured to:
receive, from the identifier manager, a portion of a permanent identifier, corresponding to the virtual identifier; and
output, to a user device, the portion of the permanent identifier.

7. A method of requesting a new virtual identifier, comprising:
receiving, at a processing device, an indication of a triggering event associated with a virtual identifier;
determining, by the processing device, to request the new virtual identifier based on the triggering event;
transmitting, from the processing device and to an identifier manager associated with the virtual identifier, a request for the new virtual identifier;
receiving, from the identifier manager and at the processing device, an indication of the new virtual identifier in response to the request; and
storing, at the processing device, the indication of the new virtual identifier, in replacement of an indication of the virtual identifier, for processing future events.

8. The method of claim 7, wherein the indication of the new virtual identifier comprises a token including an encrypted version of the new virtual identifier, and storing the indication of the new virtual identifier comprises storing the token.

9. The method of claim 7, further comprising:
discarding, at the processing device, a token including an encrypted version of the virtual identifier in response to receiving the indication of the new virtual identifier.

10. The method of claim 7, wherein transmitting the request for the new virtual identifier comprises:
performing an application programming interface (API) call to an API function associated with virtual identifier replacement.

11. The method of claim 7, wherein the request includes a set of credentials associated with the processing device.

12. The method of claim 7, wherein receiving the indication of the triggering event comprises:
receiving the indication from monitoring software executed by the processing device.

13. The method of claim 7, wherein the triggering event comprises one or more of:
an expiration associated with the virtual identifier;
a decline event associated with the virtual identifier;
a security breach associated with the processing device;
a login event associated with the processing device;
a password event associated with the processing device; or
a browsing event associated with the processing device.

14. A non-transitory computer-readable medium storing a set of instructions for processing a request for a new virtual identifier, the set of instructions comprising:
one or more instructions that, when executed by one or more processors of a device, cause the device to:
receive, from a processing device associated with the virtual identifier, the request for the new virtual identifier, wherein the request includes a reason code associated with a triggering event;
determine a response to the request; and
transmit, to the processing device, the response.

15. The non-transitory computer-readable medium of claim 14, wherein the response comprises an acceptance of the request, and wherein the one or more instructions, when executed by the one or more processors, cause the device to:
generate the new virtual identifier,
wherein the response transmitted to the processing device includes an indication of the new virtual identifier.

16. The non-transitory computer-readable medium of claim 15, wherein the one or more instructions, when executed by the one or more processors, cause the device to:
transmit, to an account manager, an instruction to replace the virtual identifier with the new virtual identifier.

17. The non-transitory computer-readable medium of claim 15, wherein the one or more instructions, when executed by the one or more processors, cause the device to:
disable the virtual identifier; and
activate the new virtual identifier.

18. The non-transitory computer-readable medium of claim 14, wherein the response comprises a rejection of the request, and wherein the response transmitted to the processing device includes a reason code associated with the rejection.

19. The non-transitory computer-readable medium of claim 14, wherein the request further includes an indication that a score, associated with the virtual identifier, satisfies a replacement threshold.

20. The non-transitory computer-readable medium of claim 14, wherein the triggering event comprises one or more of:
an expiration associated with the virtual identifier;
a decline event associated with the virtual identifier;
a security breach associated with the processing device;
a login event associated with the processing device;
a password event associated with the processing device; or
a browsing event associated with the processing device.
